(19) United States
(12) Patent Application Publication
(10) Pub. No.: US 2001/0030099 A1
(43) Pub. Date: Oct. 18, 2001

(54) Clutch system with a friction clutch and an actuation device belonging thereto

(75) Inventor: Hans Fliege, Obertheres (DE)

Correspondence Address: Klaus P. Stoffel, Esq., Cohen, Pontani, Lieberman & Pavane, Suite 1210, 551 Fifth Avenue, New York, NY, 10176, US

(73) Assignee: Mannesmann Sachs AG

(21) Appl. No.: 09/811,956

(22) Filed: Mar. 19, 2001

(30) Foreign Application Priority Data
Apr. 14, 2000 (DE) 100 18 677.7

(51) Int. Cl. F16D 25/08; F16D 13/48

(52) U.S. Cl. 192/91 A; 192/70.27; 192/85 CA; 192/30 W; 192/89.23

(57) ABSTRACT

The friction clutch comprises a clutch disk arrangement which can be brought into frictional engagement with associated friction surfaces by the action of a movably mounted thrust plate arrangement. The actuation device includes a pressure medium force cylinder arrangement by means of which the friction clutch can be actuated by an actuating member; a measuring arrangement detects an actual actuation. A control/regulating valve arrangement is connected with a pressure medium source, with a pressure compensation opening or a pressure compensation reservoir and with the pressure medium force cylinder arrangement, by means of which control/regulating valve arrangement the pressure medium force cylinder arrangement can be actuated depending on the actual actuation and on a reference actuation which can be predetermined. According to one aspect of the invention the measuring arrangement detects an adjusting path of at least one thrust plate of the thrust plate arrangement as actual actuation. According to another aspect, an energy accumulator acting so as to produce the frictional engagement has an at least approximately linear actuation-force characteristic. According to another aspect, the pressure medium force cylinder arrangement is coupled or can be coupled with the thrust plate arrangement so that a contact pressing force generated by the pressure medium force cylinder arrangement and is transmitted to the thrust plate arrangement produces the frictional engagement.

### BACKGROUND OF THE INVENTION

1. Field of the Invention

The invention is directed to a clutch system with a friction clutch and an actuation device for the friction clutch, which friction clutch is arranged in the drivetrain of a motor vehicle between a drive unit and a transmission arrangement. The friction clutch comprises a clutch disk arrangement which can be brought into frictional engagement with associated friction surfaces by the action of a movably mounted thrust plate arrangement. The actuation device comprises a pressure medium force cylinder arrangement by means of which the friction clutch can be actuated by an actuating member; a measuring arrangement detects an actual actuation. A control/regulating valve arrangement is connected with a pressure medium source, with a pressure compensation opening or a pressure compensation reservoir and with the pressure medium force cylinder arrangement, by means of which control/regulating valve arrangement the pressure medium force cylinder arrangement can be actuated depending on the actual actuation and on a reference actuation which can be predetermined.

2. Description of the Related Art

A clutch system of the type mentioned above or an actuation device for clutch actuation, particularly pneumatic actuation, is known from U.S. Pat. No. 6,116,399, the disclosure of which is incorporated herein by reference.

In the known actuation device, a measuring arrangement is provided which detects an adjusting path or an axial position of a release bearing arrangement as actual actuation. The adjusting path or the axial position of the release bearing arrangement represents the actuation state of the clutch only indirectly. As a rule, an energy accumulator acts on the thrust plate arrangement for the purpose of producing a frictional engagement and the actuating member is a release member which cooperates with the energy accumulator and adjusts the strength of the frictional engagement or cancels it. However, the quantity to be controlled or regulated is not the axial position or the adjusting path of the release bearing arrangement, but the frictional engagement and accordingly the torque which is transmitted or can be transmitted by the clutch. When the frictional engagement or the torque which is or can be transmitted is detected in the usual manner, that is, indirectly, problems may ret with the control or regulation, for example, idle times, phase displacements, hysteresis effects, and so on. The control/regulation is sharply limited with respect to the dynamics that can be achieved and instabilities, especially oscillations, can occur. This is particularly true when the energy accumulator comprises a spring arrangement with nonlinear transmission behavior, for example, a diaphragm arrangement or plate spring arrangement.

### SUMMARY OF THE INVENTION

In order to achieve movements, it is proposed according to (a first aspect of) the invention that the measuring arrangement detects an adjusting path of at least one thrust plate of the thrust plate arrangement as actual actuation.

According to the invention that the measuring arrangement, which can also be referred to as a distance or path sensor arrangement, directly detects the thrust plate movement or the instantaneous position of the thrust plate, so that nonlinear transmission behavior of components, particularly a spring arrangement serving as energy accumulator, arranged between the thrust plate and the pressure medium force cylinder arrangement and/or transmission behavior of components resulting in idle times, phase displacements, hysteresis effects, and so on, is “circumvented” to a certain extent.

The measuring arrangement have a measuring pin arrangement which is coupled with rot to movement with the thrust plate and rotates along with the latter and which transmits a signal representing an instantaneous thrust plate position to a stationary sensor arrangement. For example, the measuring arrangement can be constructed in a manner corresponding to the constructions suggested in DE 197 43 659 A1. Although DE 197 43 659 A1 itself relates to a device for determining clutch wear, its functional principles and construction details can also easily be applied to a measuring arrangement for detecting an adjusting path of at least one thrust plate in connection with the present invention. The disclosure of DE 197 43 659 A1 is incorporated in its entirety by reference in the disclosure of the present application.

It has already been mentioned that the actuating member can be a release member which cooperates with an energy accumulator acting on the thrust plate arrangement for the purpose of producing the frictional engagement. The energy accumulator can comprise a spring arrangement, if desired a diaphragm spring arrangement or plate spring arrangement or a helical compression spring arrangement.

Consequently, the invention is also specifically directed to a clutch system with a friction clutch and an actuation device for he friction clutch in the drivetrain of a motor vehicle between a drive unit and a transmission arrangement, wherein the friction clutch comprises a clutch disk arrangement which can be brought into frictional engagement with associated friction surfaces by the action of a movably mounted thrust plate arrangement. An energy accumulator acts on the thrust plate arrangement for the purpose of producing the frictional engagement; and the actuation device comprises a pressure medium force cylinder arrangement by means of which the friction clutch can be actuated by an actuating member, a arrangement detecting an actual disengagement. A control/regulating valve arrangement is connected with a pressure medium source, pressure compensation opening or pressure compensation reservoir and with the pressure medium force cylinder arrangement, by means of which control/regulating valve arrangement the pressure medium force cylinder arrangement can be actuated depending on the actual disengagement and depending on a reference disengagement which can be predetermined.

According to a second aspect of the invention which is independent from the first aspect, the energy accumulator has an at least approximately linear actuation-force characteristic.

Regardless of whether an adjusting path of at least one thrust plate of a thrust plate arrangement is detected as actual disengagement according to the first aspect of the invention or whether, as in the prior art, the measuring arrangement detects an adjusting path of a release bearing arrangement or actuating piston. The controlling and/or regulating of the friction clutch is substantially simplified according to the second aspect by the at least approximately linear actuation-force characteristic of the energy accumulator. Nonlinear actuation-force characteristics, which is a matter of course in conventional pedal-actuated clutches without external power—especially as regards comfort considerations—and which result from the nonlinear spring path/spring force characteristic of the diaphragm spring arrangements or plate spring arrangements that are usually used, make the control and/or regulation more complicated in actuation devices which are reinforced by or based on external power. In some cases, elaborate, possibly adaptive control or regulating algorithms are even required for overcoming instabilities such as oscillations and spiking and the consequences thereof.

In contrast, the second aspect provides for simplifications and improvements. The control/regulation of the clutch actuation is substantially simpler and more reliable because of the at least approximately linear actuation-force characteristic since there is a comparatively appreciably simpler relationship between the response of the friction clutch and the actuation of the pressure medium for cylinder arrangement, so that comparatively simple and consequently more reliable control and regulating strategies (control and regulating algorithms) can be used. Instability, oscillations and spiking now play, at most, an insignificant part and can be controlled easily and simply in every case.

The energy accumulator can be a spring arrangement, for example, a diaphragm spring arrangement or plate spring arrangement or a helical compression spring arrangement. According to the invention, the spring arrangement has at least approximately linear spring path/spring force characteristic.

With respect to a diaphragm spring arrangement or plate spring arrangement, it is suggested that the bend or curve parameters characterizing the spring path/spring force curve which corresponds to the quotient of the maximum spring path between the relaxed state of a plate spring and the plane state of the plate spring (=dividend) and of the plate thickness (=divisor) does not exceed 1.0. The residual nonlinearity occurring with a curve parameter of 1.0 can be controlled in a comparatively simple and reliable manner. However, the residual nonlinearity should preferably be smaller than the residual nonlinearity occurring at a curve parameter of 1.0. Accordingly, it is suggested, for example, that a curve parameter of about 0.6 to 0.8 or, preferably, a curve parameter below 0.6, is provided.

When the spring arrangement is not formed by a diaphragm spring arrangement or plate spring arrangement, residual nonlinearities of the spring path/spring force characteristic similar to those in a diaphragm spring arrangement or plate spring arrangement are acceptable. However, it is preferable that the spring path/spring force characteristic is substantially linear. This can be achieved, for example, by means of a spring arrangement constructed as a helical compression spring arrangement.

According to a third aspect of the invention, it is suggested for the clutch system mentioned in the beginning that the pressure medium force cylinder arrangement is coupled with or can be coupled with the thrust plate arrangement in such a way that a contact pressing force which is generated by the pressure medium force cylinder arrangement and is transmitted to the thrust plate arrangement produces the frictional engagement.

While an energy accumulator or the like conventionally serves to generate the contact pressing force producing the frictional engagement and the pressure medium force cylinder arrangement serves to generate a releasing force, it is proposed according to the invention that the contact pressing force is generated by the pressure medium force cylinder arrangement, so that a (static) energy accumulator such as a diaphragm spring arrangement or plate spring arrangement can be dispensed with.

Since a corresponding pressure media pressure must be maintained for holding the friction clutch in the engaged state in the pressure medium force cylinder arrangement, any leakage losses must be compensated by corresponding control of the control/regulating valve arrangement. An advantage of the solution according to the invention is the possibility that the contact pressure force can be directly controlled or regulated in a manner tailored to the specific situation.

For this purpose, the measuring arrangement can have a pressure sensor arrangement which detects a pressure medium pressure occurring in the pressure medium force cylinder arrangement as a quantity representing the actual actuation.

Another possibility consists in that the measuring arrangement has a force sensor arrangement which detects the contact pressing force transmitted to the thrust plate arrangement as a quantity representing the actual actuation.

Further, it is possible that the measuring arrangement has a path sensor arrangement which detects an adjusting path of the actuation member, possibly of an actuation piston of the pressure medium force cylinder arrangement and/or of at least one thrust plate of the thrust plate arrangement as a quantity representing the actual actuation. In this respect, an inherent elasticity of the friction facing of the clutch disk arrangement and possibly the elasticity of a facing suspension makes possible a definite adjustment of the contact pressing force via the adjusting path, so that a defined engagement/release is possible with adequate comfort.

In general, it is suggested that a control/regulating unit controlling the control/regulating valve arrangement is constructed for moving the friction clutch into a completely engaged state and/or holding it in a completely engaged state in order to adjust a pressure excess of the pressure medium pressure in the pressure medium force cylinder arrangement. In this way, a slipping of the clutch can be safely prevented also in case of torque peaks, e.g., by a 3 bar increase in pressure in the pressure medium force cylinder arrangement for the engaged state.

The actuation device is preferably constructed in such a way that pressure forces acting on an actuating piston of the pressure medium fore cylinder arrangement for purposes of displacement can be transmitted to the thrust plate arrangement as contact pressing force and can be supported via the clutch disk arrangement.

It should be mentioned with regard to all aspects of the invention that the pressure medium force cylinder arrangement is preferably a pneumatic force cylinder arrangement comprising, for example, a ring cylinder surrounding an axis of rotation of the friction clutch. The control/regulating valve arrangement is preferably an electrically controllable valve arrangement.

The invention is further directed to an actuation device for a friction clutch arranged in the drivetrain of a motor vehicle between a driving unit and a transmission arrangement for building a clutch system as described above. Reference is had to the preceding description of the clutch system according to the invention, especially to the statements regarding the actuation device.

The invention is further directed to a motor vehicle drivetrain comprising a drive unit, a transmission arrangement and a clutch system according to at least one aspect of the invention.

The invention will be explained more fully with reference to embodiment examples shown in the Figures.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partly schematic partial longitudinal sectional view of an actuation device for a motor vehicle friction clutch with a pressure medium force ring cylinder, especially a pneumatic force ring cylinder in the moved out state;

FIG. 2 is a schematic sectional view showing a measuring arrangement for detecting an adjusting path of a thrust plate of a friction clutch;

FIG. 3 is a schematic view showing a drivetrain of a motor vehicle with an engine, a transmission, a friction clutch and an actuation device for the friction clutch;

FIG. 4 shows a clutch system comprising a friction clutch with a diaphragm spring or plate spring serving as engagement spring and an actuation device acting on the diaphragm spring or plate spring, wherein a measuring arrangement of the kind shown in FIG. 2 is indicated in dashes;

FIG. 5 shows a spring path/spring force chart with spring path/spring force characteristics of plate springs for different spring parameters (curve parameters);

FIG. 6 shows a variant of the clutch system of FIG. 4 with a compression spring arrangement instead of a plate spring;

FIG. 7 is a view corresponding to FIG. 4 showing another embodiment example of a clutch system comprising a friction clutch and an actuation device, wherein a pressure medium force ring cylinder, especially a pneumatic force ring cylinder, of the actuation device serves to generate a contact pressing force moving the friction clutch into frictional engagement;

FIG. 8 shows a variant of the clutch system of FIG. 7 in which a force measuring element of a measuring arrangement detecting an actual actuation is arranged between the pressure medium force ring cylinder and a thrust plate of the friction clutch.

### DETAILED DESCRIPTION OF THE PRESENTLY PREFERRED EMBODIMENTS

The basic construction and manner of operation of an actuation device 10 used, for example, in commercial or utility vehicles will be described first with reference to FIG. 1. The actuation device 10 is constructed in such a way that it surrounds an axis of rotation A of a motor vehicle friction clutch, not shown in FIG. 1, essentially concentrically and various components of the same are constructed in a ring-shaped manner and surround the axis of rotation A.

A housing 12 of an actuation unit 13 of the actuation device 10 in which a valve arrangement 14 is integrated is shown on the radial outer side. Located on the radial inner side of the valve arrangement 14 is a measuring arrangement 16 which has a measuring element 18 that can be displaced in the direction of the axis of rotation A and which is arranged so as to be displaceable in a chamber 20 which is constructed in the housing 12 and open on one axial side.

At its end projecting from the chamber 20, the measuring element 18 is in a displacement engagement with an annularly constructed pressure medium force piston 26. The pressure medium force piston 26 belongs to a pressure medium force cylinder arrangement 28. In the present case, the pressure medium force cylinder arrangement is a pneumatic force cylinder arrangement which will be referred to hereinafter for the sake of brevity as actuation cylinder 28. The actuation piston (possibly a release piston) 26 which is constructed as a ring piston is displaceable in direction of the axis of rotation A. A ring cylinder space 29 is defined by a tubular part 30 and an annular wall part 31 with a radial outer wall part 32 and a bottom portion 33 and a piston element 34 of the piston 26 engaging in the ring cylinder space 29. Different sealing elements which seal the ring cylinder space 29 so as to be tight against pressure medium, particularly pneumatically tight, act between the piston 26, particularly its piston element 34, and the pipe part 30 and the wall part 31.

A pretensioning compression spring 38 is received in the ring cylinder space 29. This pretensioning compression spring 38 pretensions the piston 26 in the direction of the stop of a pivot bearing 40, possibly a release bearing 40, which is fixedly coupled to the piston 26 and located at an associated force reception arrangement, possibly an engagement spring arrangement (for example, a diaphragm spring arrangement or plate spring arrangement or the like) of the friction clutch.

The pivot bearing 40 comprises two bearing shells 48, 50, known per se, between which bearing balls 52 are arranged. The bearing shell 48 is coupled with a displacing part 44 of the actuation piston 26 and the bearing shell 50 is rotatable about the axis of rotation A with respect to these structural component parts and cooperates with the force reception arrangement of the clutch or, in the case of the engagement spring arrangement, with spring tabs or the like (in the case of the engagement spring arrangement for releasing the clutch).

Referring to the possible construction with an engagement spring arrangement, the actuation device is constructed for working together with a pushed clutch in the present embodiment form, but conversion would be possible for working with a pulled clutch without extensive structural modifications.

The valve arrangement 14 is connected to a pneumatic source 63 via a connection 62 of the housing 12. Further, the valve arrangement 14 is connected to a pressure compensation opening 66 via a connection 64 of the housing 12. Finally, the valve arrangement 14 is connected to the ring cylinder space 29 of the actuation cylinder 28 via a connection 68 of the housing and a connection 70 of the actuation cylinder 28. The valve arrangement can occupy a holding position in which the ring cylinder space 29 is closed, a compressed air feed position in which a compressed air feed connection is produced between the pneumatic source 63 and the ring cylinder space 29 by the valve arrangement, and a venting position in which a venting connection is produced between the ring cylinder pace 29 and the pressure compensation 66 by the valve arrangement. There are no restrictions regarding the construction of the valve arrange they can be formed, for example, by a plurality of switching valves or one or more proportional valves.

In the embodiment example shown, the measuring arrangement 16 works magnetically. The measuring arrangement 16 comprises a coil body 80 which works together with a magnet element 82 fixed to the inner end of the measuring element 18 and supplies an electric signal representing the axial position of the magnet element 82 to a control/regulating unit 86 via electric lines 84. Since the measuring element 18 is movement-coupled with the release piston 26 and is displaced synchronous to the latter in direction of axis A, the signal transmitted to the control/regulating unit 86 on the lines 84 represents the actual disengagement or actual position of the release piston or actuation piston 26 and—in the case of engagement between the force reception arrangement constructed as an engagement spring arrangement and the pivot bearing 40 (referred to in this instance as release bearing 40)—the actual disengagement or releasing of the friction clutch.

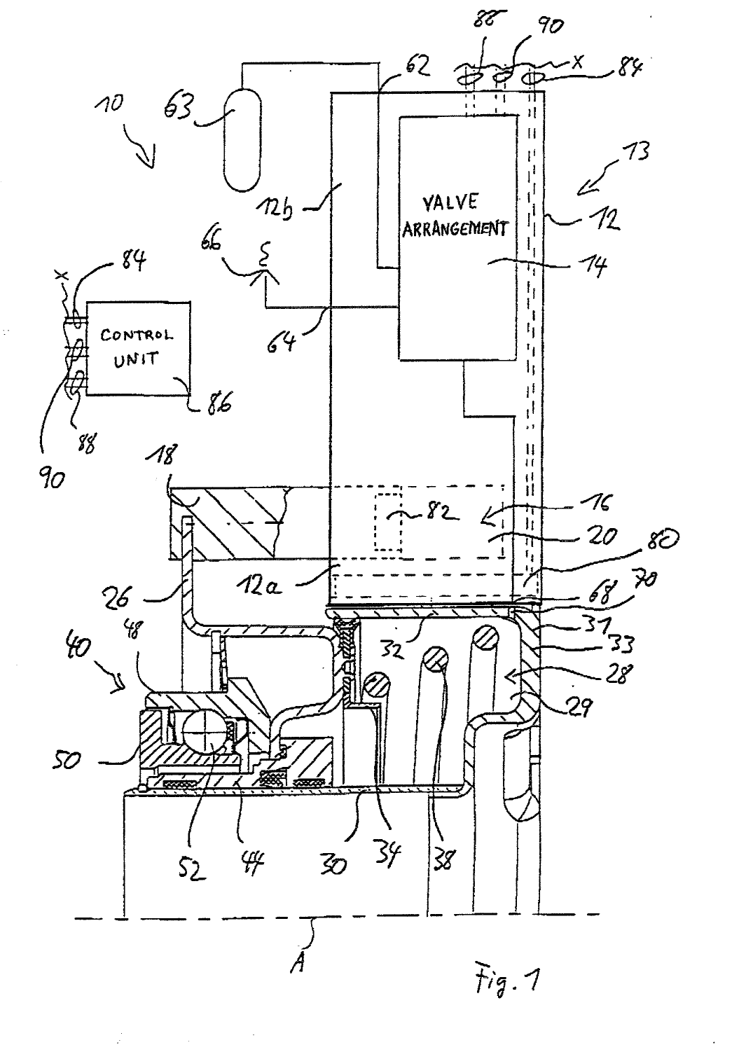

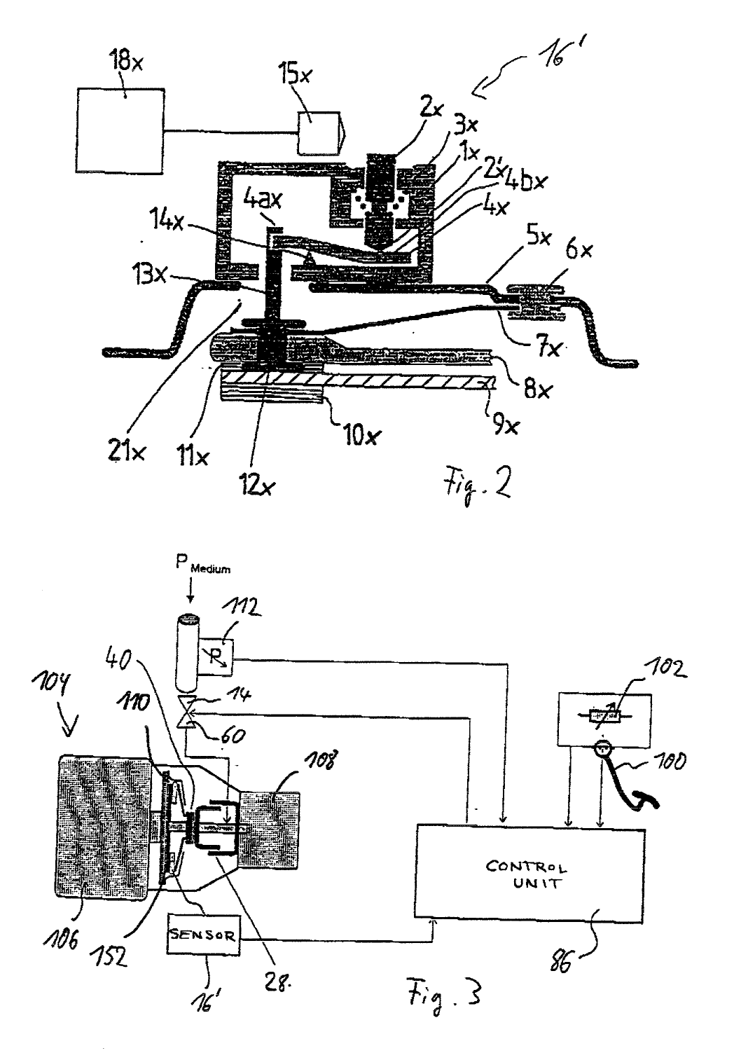

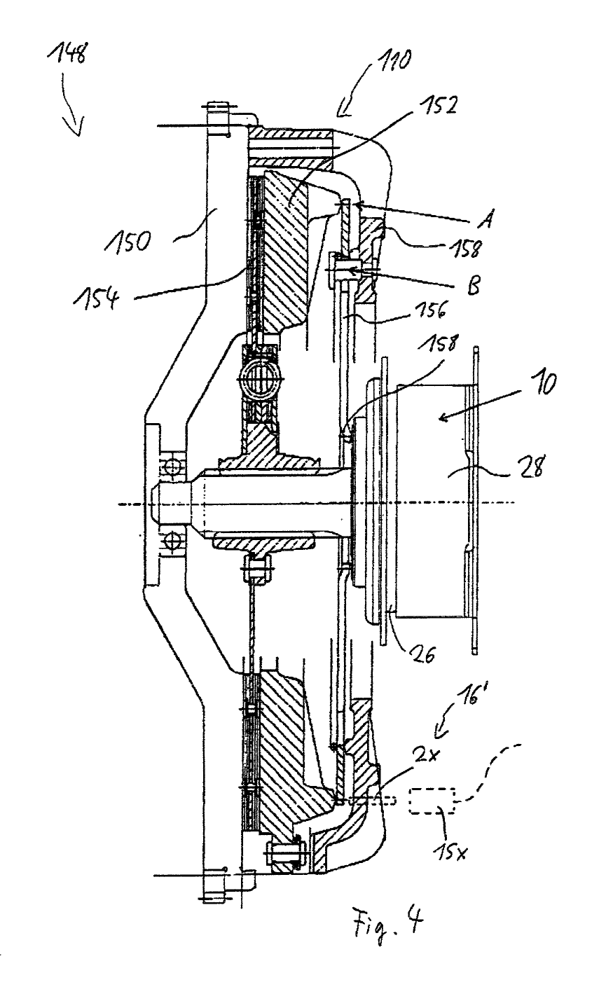

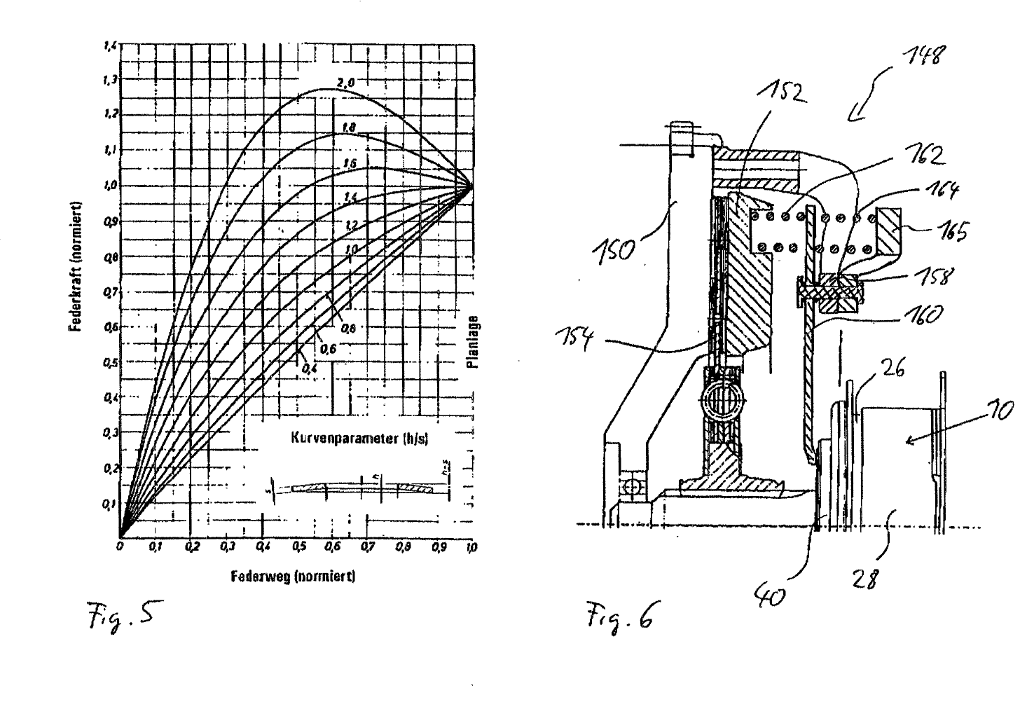

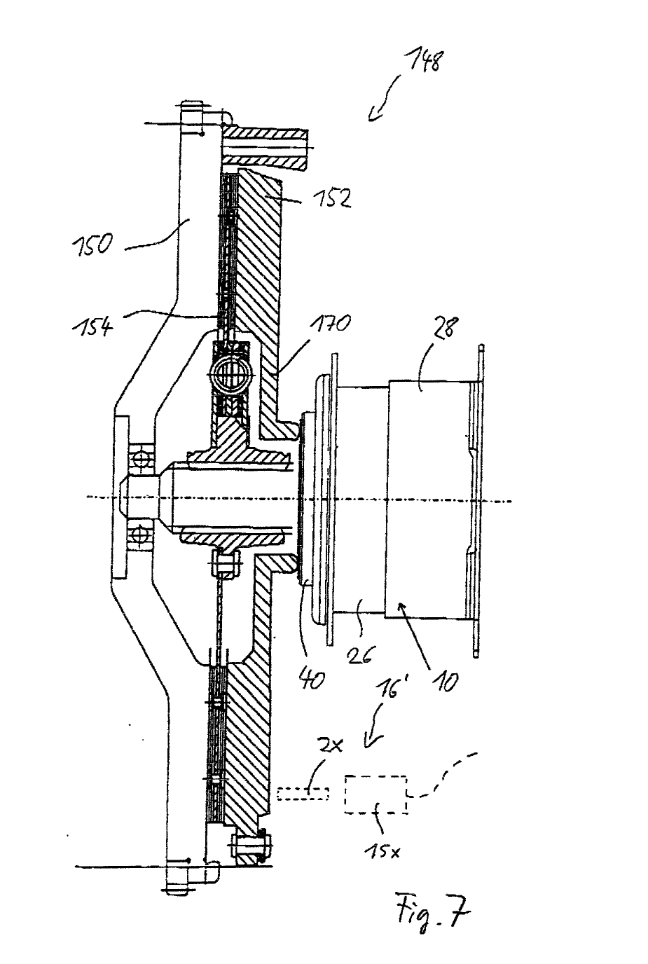

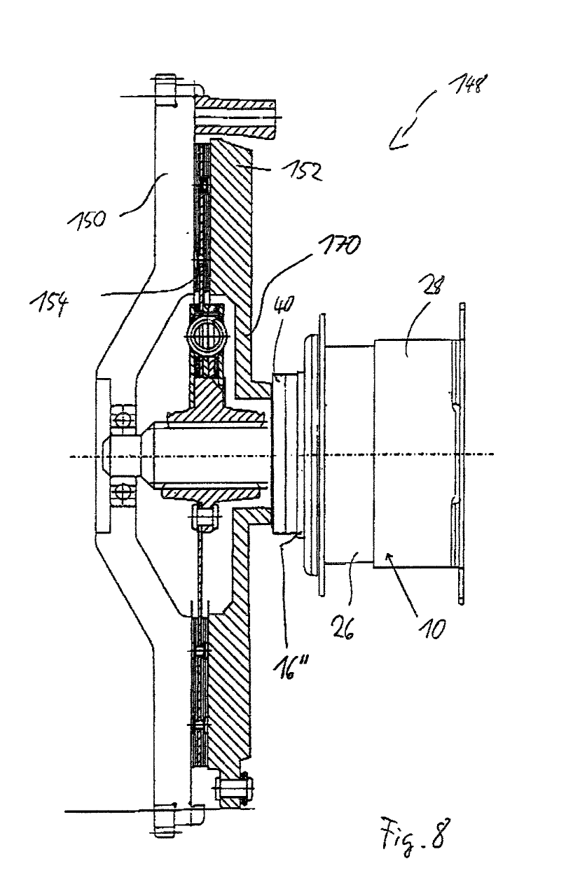

Referring to the embodiment examples in FIGS. 7 and 8, the actuation cylinder 28 can serve alternatively to generate contact pressing forces moving the friction clutch into frictional engagement while dispensing with an engagement spring arrangement. In this case, for example, a thrust plate of the friction clutch can serve as a force reception arrangement. The pivot bearing 40 could conceivably be referred to as an engagement bearing in this case.

For clutch actuation, the control/regulating unit 86 actuates the valve arrangement 14 so that the actual actuation approximates the reference actuation and, ideally, corresponds to it, depending on a command variable or control input giving a reference actuation (reference disengagement or, in the construction according to FIGS. 7 and 8, a reference engagement), and depending on the actual actuation (actual disengagement or, in the construction according to FIGS. 7 and 8, actual engagement) detected by means of the sensor 80, 82, and possibly depending on additional data. For this purpose, the control/regulating unit adjusts the holding position, the compressed air feed position, the venting position of the valve arrangement 14 via electric lines 88, 90 as required.

An electrical interface between the valve arrangement 14 and the control/regulating unit 86 is represented in FIG. 1 by an intersection line X. The interface can be formed by a plug connector arrangement, generally an electric connector, for example, a plug connector strip at the housing 12 or a plug connector at a free end of a multiwire cable or cable tree that is fixed with respect to the housing. Connections 62 and 64 for the pneumatic source 63 and the pressure compensation open 66 can also be constructed in detachable manner and, for example, comprise connection nipples or the like which are fixed with respect to the housing.

The command variable on the basis of which the control/regulating unit 86 actuates the valve arrangement 14 and accordingly the actuation cylinder 28 and consequently the friction clutch can be provided by vehicle electronics or the like. However, it is also possible to derive the command variable from the actuation of a clutch pedal 100, an electric signal transmitter 102 (for example, a potentiometer) being associated with the latter (see FIG. 3).

Instead of the measuring arrangement 16 or in addition to it, a measuring arrangement 16′ corresponding to FIG. 2 can be provided. FIG. 2 corresponds to FIG. 1 of DE 197 43 659 A1, wherein the reference numbers from this Laid Open Application have been retained and supplemented by a lowercase ‘x’ to differentiate the reference numbers used in the present specification. Reference is had expressly to the statements in DE 197 43 659 A1.

FIG. 2 shows a schematic sectional view of an upper half-portion of a friction clutch comprising a clutch housing 5x, a thrust plate 8x which is arranged therein so as to be axially movable and which serves to press a clutch disk 9x against a flywheel. The thrust plate is fastened to the clutch housing 5x via a plurality of leaf springs (straps) 7x which are connected with the thrust plate 8x by one end and with the clutch housing 5x by their other end. Rivets 6x, 12x are used for connecting.

A sensing pin 13x communicates with the thrust plate 8x via the rivet 12x. The sensing pin 13x projects through a recess 21x provided in the clutch housing 5x axially out of the clutch housing 5x into a housing 1x which is fastened to the clutch housing 5x. The sensing pin 13x can be constructed in one piece with the rivet 12x. The sensing pin 13x communicates with an indicator pin 2x via a weighing bar 4x which is swivelable about a bearing 14x constructed in the housing 1x. For this purpose, the weighing bar 4x is connected by one of its ends 4ax with the sensing pin 13x in a positive engagement. In the region of the other end 4bx, the indicator pin 2x is supported on the weigh bar 4x by the tip 2′x. The bearing 14x is arranged in such a way that an axial movement of the sensing pin 13x is converted into a greater axial movement of the indicator pin 2x.

The indicator pin 2x is held in the housing 1x via a compression spring 3x, which biases the pin toward the weighing bar 4x, and is guided out of the housing 1x axially. In contrast to the suggestion in DE 197 43 659 A1, there is no clamping spring or the like which fixes the indicator pin 2x in such a way that the latter only moves out of the housing 1x but not back into it again. The arrangement is accordingly constructed in such a way that the indicator pin 2x follows the engaging and releasing movements of the thrust plate.

A sensor 15x is provided outside of the housing 1x and is connected with an evaluating unit 18x (for example, the control/regulating unit 86 in FIG. 1) and detects the adjusting movements of the indicator pin 2x out of the housing 1x and back into the housing 1x due to clutch actuations.

The measuring arrangement 16′ in FIG. 2 makes it possible for the actuation path of the thrust plate to be detected directly by means of one or more stationary sensors 15x, wherein the indicator pin 2x rotating along with the clutch or, preferably, a plurality of indicator pins 2x which are offset with respect to one another in circumferential direction and coupled with the thrust plate via a mechanism according to FIG. 2 moves past the stationary sensor(s) 15x.

Assuming a minimum clutch speed (idling speed) of about 300 RPM in commercial vehicles and about 600 RPM in passenger vehicles, the sensor 15x can detect a path measurement value every 200 ms or every 100 ms with respect to an indicator pin 2x. Depending on the minimum adjusting time for a complete disengagement or engagement, a corresponding quantity of sensing pins and indicator pins is provided to make possible stable regulation/control. At a minimum adjusting time of 100 ms, for example, it is typically sufficient when there is a measurement value every 5 ms to 10 ms, the control valve arrangement being controlled on the basis of this measurement value. Accordingly, for example, 10 or 20 indicator pins could be provided or an indicator ring could be provided which is carried by a plurality of indicator pins and its axial position is detected by the sensor 15x. Further, it is also possible to provide a plurality of sensor 15x which are offset relative to one another in circumferential direction.

FIG. 3 shows schematically a drivetrain 104 with an engine 106, a transmission 108 and a friction clutch 110, which latter can be actuated by means of a release cylinder or actuation cylinder 28 that acts on an engagement spring arrangement 111 of the friction clutch via a release bearing 40. A sensor 16′ detecting the thrust plate movement is shown schematically in FIG. 3 as the sensor detecting the actual disengagement. This can be a sensor 16′ corresponding to the sensor 16′ in FIG. 2. According to FIG. 3, the control/regulating unit also receives an electric signal from a pressure sensor 112 which measures the pressure of the compressed air delivered by the pneumatic source 63, not shown in FIG. 3.

FIG. 4 shows a clutch system with a friction clutch 110 comprising a clutch disk 154 arranged between a flywheel 150 and a thrust plate 152 and a plate spring 156 which serves as an engagement spring and which is supported at the clutch housing 158 at B and acts on the thrust plate 152 at A for the purpose of engagement. The clutch system 148 further comprises an actuation device 10, for example, corresponding to FIG. 1 which has a pressure-medium-actuated, particularly a pneumatically actuated release cylinder 28 which acts on spring tongues 158 of the plate spring 156 via a release bearing. The actuation device 10 can contain a measuring arrangement 16′ according to the principle of operation of one of the construction variants shown in DE 197 43 659 A1 which detects the axial movement of the thrust plate 152. Reference is had to the above statements in connection with FIG. 2.

Conventional plate springs or diaphragm springs serving as engagement springs for friction clutches are dimensioned in such a way that they have an extensively nonlinear spring path/spring force characteristic. Referring to the spring path/spring force graph in FIG. 5, diaphragm springs with a curve parameter in the range of 1.7 to 1.8 are usually used. A quantity h/s or h′/s corresponding to the quotient of the maximum spring path h between a relaxed state of the plate spring and a flat state of the plate spring and the spring thickness s is referred to as curve parameter. Reference is had to German Industrial Standard DIN 2093.

FIG. 5 makes it clear that almost linear force/path characteristics can be realized in addition to sharply curved (extensively nonlinear) force/path characteristics depending on the dimensioning of the plate spring. Departing from current practice, it is suggested according to an aspect of the invention to provide an engagement spring or engagement spring arrangement with an at least approximately linear spring path/spring force characteristic, for example, a diaphragm spring or plate spring with a curve parameter of less than or equal to 1.0, preferably in the range of 0.4 to 0.8. The transition to an at least approximately linear spring characteristic offers great advantages with respect to the expenditure required for an exact and reliable control or regulation of the clutch actuation. When the spring characteristic has essentially the same slope along the entire usable range, extremely simple control and regulating algorithms can be used without the risk of instability, e.g., oscillations.

To a certain extent, introducing an essentially or approximately linear spring characteristic means a change in paradigm. Conventionally, with respect to a foot-operated clutch, an extensively nonlinear force/path relationship caused the spring force to remain approximately constant over a certain spring path range. The convenience of actuation achieved by means of a nonlinear spring characteristic and the comparatively large spring path appeared indispensable in practice. It has now been recognized that an at least approximately linear spring characteristic can be provided in an actuation device assisted by or based on external force without forfeiting comfort, for example, in order to achieve the aforementioned advantages with respect to simple control or regulation. Regarding the spring path which is reduced with a linear diaphragm spring compared to a nonlinear diaphragm spring, it was recognized in addition that an unchanged release bearing path can be realized in spite of the smaller spring path, for example, in that the contact points A and B of the diaphragm spring for adjusting a lever ratio giving the desired release bearing path are selected so as to match the spring force (spring thickness) and maximum spring path (see FIG. 4).

FIG. 6 shows a construction variant of the clutch system 148 of FIG. 4 provided with an engagement spring arrangement formed by a plurality of helical compression springs. A plurality of helical compression springs 162 are arranged between the thrust plate 152 and a plurality of release levers 160 which are offset relative to one another in circumferential direction, wherein each helical compression spring 162 is associated with a release lever 160. The release levers 160 are levers of the first class and are swivelably supported at the clutch housing 158.

An addition helical compression spring 164 which is arranged on the other axial side of the respective release lever 160 and tensioned between it and a supporting ring 165 arranged at the clutch housing is associated with each helical compression spring 162. The compression springs 162 on the one hand and compression spring 164 on the other hand are connected in series in a certain way and, when the actuation cylinder 28 does not exert any releasing forces on the radial inner lever ends, act on the thrust plate 152 for the purpose of engagement of the friction clutch. By means of actuating the release cylinder 28, the radial outer lever ends can be displaced in the direction of the supporting ring 165 accompanied by compression of the respective helical compression springs 164 and relaxing of the respective helical compression springs 162 by pressing the radial inner lever ends in the direction of the clutch disk 154, so that the contact pressing forces acting on the thrust plate 152 are reduced and, by releasing the actuation piston to a corresponding extent, the friction clutch is finally disengaged, that is, the thrust plate 152 is raised from the clutch disk 154 by the action of associated air springs or the like. The release levers 160 are preferably constructed so as to be rigid with respect to bending, so that no nonlinearities are introduced in the force transmission path between the release cylinder 28 and the compression spring arrangement 162, 164. Since helical compression springs, as is well known, have an essentially linear spring path/spring force characteristic, there is an essentially linear relationship between the release path of the actuation piston of the actuation cylinder 28 on the one hand and the contact pressing force of the thrust plate 152 against the clutch disk 154 on the other hand.

In the embodiment examples in FIGS. 4 and 6, the contact pressing force producing the frictional engagement of the friction clutch is generated by an engagement spring arrangement (plate spring arrangement 156 or compression spring arrangement 162, 164), and the pressure medium force cylinder arrangement serves to generate the release forces releasing the friction clutch. In contrast, the pressure medium force cylinder arrangement 28 in the embodiment example in FIG. 7 in which there is no engagement spring arrangement is provided for generating engagement forces. For this purpose, the thrust plate 152 has an inner portion 170 which projects radially inward and axially toward the actuation piston 28, wherein the actuation piston 26 of the actuation cylinder 28 acts at the portion 170 with a pivot bearing 40. The actuation cylinder 28 can be constructed according to the embodiment example in FIG. 1 and can have a pretensioning spring 38 which pretensions the piston 26, or more precisely the pivot bearing 40, against the inner portion 170. Air springs or the like, not shown in FIG. 7, which act on the thrust plate 152 are dimensioned in such a way that they can release the friction clutch against the action of the pretensioning spring of the actuation cylinder 28.

The control/regulation of the frictional engagement of the friction clutch can be carried out based on detection of the axial position of the thrust plate 152 (measuring arrangement 16′) or based on detection of the axial position of the actuation piston 26 or pivot bearing 40 (for example, by means of a measuring arrangement corresponding to the measuring arrangement 16 in FIG. 1) because, based on an inherent elasticity of the friction facings and of a facing suspension that is generally provided, the contact pressing force producing the frictional engagement of the friction clutch is a function of the axial position of the thrust plate 152. Another possibility is direct detection of the pressure medium pressure, particularly pneumatic pressure, prevailing in the cylinder space of the actuation cylinder 28 because this directly determines the pressure forces exerted by the actuation piston 26 on the thrust plate 152 via the pivot bearing 40. Another possibility is illustrated graphically in FIG. 8. In this case, the actuation piston 26 carries a force measuring element 16″ on which the pivot bearing 40 is arranged. The force transmission path between the actuation piston 26 and the thrust plate 152 accordingly extends along the force measuring clement 16″, so that the pressure force exerted on the thrust plate 152 is detected directly. In this way, the “actual actuation” of the friction clutch is detected in a simple and reliable manner.

The approach realized in the embodiment examples in FIGS. 7 and 8, namely, that the contact pressing force producing the frictional engagement is applied by the pressure medium force cylinder arrangement, enables a direct control and regulation of this contact pressing force in a simple manner by means of corresponding actuation of the pressure medium force cylinder arrangement. The control and regulating algorithms which can be used for this purpose may be comparatively simple because the pressure medium force cylinder acts directly on the thrust plate and, to this extent, no transmission characteristic of an engaging spring arrangement or the like need be taken into account. The fact that the actuation cylinder in the engaged state of the friction clutch must always be kept under pressure when the clutch system is constructed in the manner described above does not present problems with present-day low-leakage actuation cylinders, particularly ring cylinders. Any leakage losses can be compensated by corresponding regulation based on the detection of the actual actuation. In summary, the invention is directed to a clutch system with a friction clutch and an actuation device for the friction clutch which is arranged in the drivetrain of a motor vehicle between a drive unit and a transmission arrangement, wherein the friction clutch comprises a clutch disk arrangement which can be brought into a frictional engagement with associated friction surfaces by the action of a movably mounted thrust plate arrangement. The actuation device comprises a pressure medium force cylinder arrangement by means of which the friction clutch can be actuated by an actuating member; a measuring arrangement detects an actual actuation. A control/regulating valve arrangement is connected with a pressure medium source, pressure compensation opening or pressure compensation reservoir and with the pressure medium force cylinder arrangement, by means of which control/regulating valve arrangement the pressure medium force cylinder arrangement can be actuated depending on the actual actuation and depending on a reference actuation which can be predetermined. According to one aspect of the invention it is suggested that the measuring arrangement detects an adjusting path of at least one thrust plate of the thrust plate arrangement as actual actuation. According to another aspect, it is suggested that an energy accumulator which acts so as to produce the frictional engagement has an at least approximately linear actuation-force characteristic. According to another aspect, it is suggested that the pressure medium force cylinder arrangement is coupled or can be coupled with the thrust plate arrangement in such a way that a contact pressing force which is generated by the pressure medium force cylinder arrangement and which is transmitted to the thrust plate arrangement produces the frictional engagement.

Thus, while there have shown and described and pointed out fundamental novel features of the invention as applied to a preferred embodiment thereof, it will be understood that various emissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. A clutch system for a drive train of a motor vehicle, said clutch system comprising
a friction clutch comprising a clutch disk and a thrust plate mounted to move axially to frictionally engage or disengage said clutch disk when said friction clutch is actuated,
an actuation device comprising a pressure medium force cylinder and an actuating member which moves in response to pressure in said cylinder when said friction clutch is actuated,
a measuring arrangement which detects movement of said thrust plate as an actual actuation of the friction clutch,
a pressure medium source,
a pressure compensation opening, and
a control/regulating valve arrangement connected to said pressure medium source, said pressure compensation opening, and said pressure medium force cylinder, said control regulating valve arrangement acting to control the pressure of said medium in said cylinder based on the actual actuation and a reference actuation which can be predetermined.

2. A clutch system according to claim 1 wherein said measuring arrangement comprises
an indicator pin which is coupled with respect to movement of the thrust plate and which rotates with the thrust plate, and
a stationary sensor arrangement which senses the instantaneous position of the indicator pin.

3. A clutch system according to claim 1 wherein said friction clutch further comprises an energy accumulator which maintains frictional engagement between the clutch disk and the thrust plate when the friction clutch is not actuated, said actuating member being a release member which acts to disengage said clutch disk and said thrust plate when the friction clutch is actuated.

4. A clutch system according to claim 3 wherein said energy accumulator comprises a spring arrangement which is one of a diaphragm spring arrangement, a plate spring arrangement, and a helical compression spring arrangement.

5. A clutch system for a drive train of a motor vehicle, said clutch system comprising
a friction clutch comprising a clutch disk, a thrust plate mounted to move axially to disengage said clutch disk when said friction clutch is actuated, and an energy accumulator which maintains frictional engagement between the clutch disk and the thrust plate when the friction clutch is not actuated, said energy accumulator having an at least approximately linear actuation-force characteristic,
an actuation device comprising a pressure medium force cylinder and an actuating member which moves in response to pressure in said cylinder to actuate said friction clutch,
a measuring arrangement which detects an actual disengagement of the friction clutch,
a pressure medium source,
a pressure compensation opening, and
a control/regulating valve arrangement connected to said pressure medium source, said pressure compensation opening, and said pressure medium force cylinder, said control regulating valve arrangement acting to control the pressure of said medium in said cylinder based on the actual disengagement and a reference disengagement which can be predetermined.

6. A clutch system according to claim 5 wherein said energy accumulator comprises a spring arrangement which is one of a diaphragm spring arrangement, a plate spring arrangement, and a helical compression spring arrangement.

7. A clutch system according to claim 6 wherein said spring arrangement is one of a diaphragm spring arrangement and a plate spring arrangement, said spring arrangement having a plate thickness (s) and a maximum spring path (h) between the a relaxed state of the spring and a plane state of the spring, said spring arrangement having a curve parameter (h/s) of about 0.4 to 0.

8. A clutch system according to claim 6 wherein said spring arrangement is a helical compression spring arrangement having a spring path/spring force characteristic with a residual nonlinearity corresponding to a curve parameter of 0.4 to 0.8.

9. A clutch system according to claim 6 wherein said spring arrangement is a helical compression spring arrangement having a spring path/spring force characteristic which is substantially linear.

10. A clutch system as in claim 5 wherein said pressure medium force cylinder comprises a pneumatic force ring cylinder.

11. A clutch system for a drive train of a motor vehicle, said clutch system comprising
a friction clutch comprising a clutch disk and a thrust plate mounted to move axially to frictionally engage said clutch disk when said friction clutch is actuated,
an actuation device comprising a pressure medium force cylinder and an actuating member which moves in response to pressure in said cylinder and transmits a contact pressing force to said thrust plate when said friction clutch is actuated,
a measuring arrangement which detects an actual actuation of the friction clutch,
a pressure medium source,
a pressure compensation opening, and
a control/regulating valve arrangement connected to said pressure medium source, said pressure compensation opening, and said pressure medium force cylinder, said control regulating valve arrangement acting to control the pressure of said medium in said cylinder based on the actual actuation and a reference actuation which can be predetermined.

12. A clutch system according to claim 11 wherein said measuring arrangement comprises a pressure sensor for detecting the pressure in the pressure medium cylinder, which pressure represents the actual actuation.

13. A clutch system according to claim 11 wherein said measuring arrangement comprises a force sensor which for detecting the contact force transmitted to the thrust plate, which contact forces represents the actual actuation.

14. A clutch system according to claim 11 wherein the measuring arrangement comprises a path sensor which detects movement of at least one of the actuation member and the thrust plate, which movement represents the actual actuation.

15. A clutch system according to claim 11 further comprising a control/regulating unit which controls the control/regulating valve arrangement for one of increasing the pressure in the cylinder, thereby engaging the clutch, maintaining pressure in the cylinder, thereby holding the clutch in an engaged state, and decreasing the pressure in the cylinder, thereby disengaging the clutch.

16. A clutch system according to claim 11 wherein said actuating member comprises an actuating member in said pressure medium force cylinder, said piston moving in response to pressure in said cylinder to transmit said contact pressing force to the thrust plate, said clutch supporting said contact pressing force.

17. A clutch system according to claim 1 wherein said pressure medium force cylinder comprises a pneumatic ring cylinder.

18. A clutch system according to claim 5 wherein said pressure medium force cylinder comprises a pneumatic ring cylinder.

19. A clutch system according to claim 11 wherein said pressure medium force cylinder comprises a pneumatic ring cylinder.

20. Actuation device for a clutch system in a drive train of a motor vehicle, said clutch system comprising a friction clutch comprising a clutch disk and a thrust plate mounted to move axially to frictionally engage or disengage said clutch disk when said friction clutch is actuated, a measuring arrangement which detects movement of said thrust plate as an actual actuation of the friction clutch, a pressure medium source, a pressure compensation opening, and a control valve arrangement connected to said pressure medium source and said pressure compensation opening, said actuation device comprising
a pressure medium force cylinder and an actuating member which moves in response to pressure in said cylinder when said friction clutch is actuated, said pressure medium force cylinder also being connected to said control valve arrangement, said control valve arrangement acting to control the pressure of said medium in said cylinder based on the actual actuation and a reference actuation which can be predetermined.
